(19) United States
(12) Patent Application Publication
(10) Pub. No.: US 2022/0212293 A1
(43) Pub. Date: Jul. 7, 2022

(54) LEAD-FREE SOLDER ALLOY, SOLDER PASTE COMPRISING THE SAME, AND SEMICONDUCTOR DEVICE COMPRISING THE SAME

(71) Applicant: MK ELECTRON CO., LTD., Yongin-si (KR)

(72) Inventors: Jae Yeol SON, Yongin-si (KR); Jeong Tak MOON, Suwon-si (KR); Jae Hun SONG, Yongin-si (KR); Young Woo LEE, Yongin-si (KR); Seul Gi LEE, Yongin-si (KR); Min Su PARK, Yongin-si (KR); Hui Joong KIM, Seoul (KR)

(73) Assignee: MK ELECTRON CO., LTD., Yongin-si (KR)

(21) Appl. No.: 17/558,989

(22) Filed: Dec. 22, 2021

(30) Foreign Application Priority Data
Dec. 23, 2020 (KR) 10-2020-0182431
Dec. 22, 2021 (KR) 10-2021-0184915

(51) Int. Cl. B23K 35/26; B23K 35/02

(52) U.S. Cl. CPC B23K 35/262; B23K 2103/08; B23K 35/025

(57) ABSTRACT

A lead (Pb)-free, and silver (Ag)-free solder alloy includes a primary metallic element in a content of about 1.1 wt % to about 1.9 wt %, nickel(Ni) in a content of about 0.02 wt % to about 0.09 wt %, copper (Cu) in a content of about 0.2 wt % to about 0.9 wt %, and tin (Sn) and other unavoidable impurities in remaining balance, wherein the primary metallic element is at least one selected from the group including bismuth (Bi), chromium (Cr), indium (In), antimony (Sb), silicon (Si) and zinc (Zn).

### CROSS-REFERENCE TO RELATED APPLICATION

This application is based on and claims priority under 35 U.S.C. § 119 to Korean Patent Application Nos. 10-2020-0182431, filed on Dec. 23, 2020, 10-2021-0184915, filed on Dec. 22, 2021, in the Korean Intellectual Property Office, the disclosures of which are incorporated by reference herein in their entireties.

### BACKGROUND

### 1. Field

The disclosure relates to a lead-free solder alloy, a solder paste including the lead-free solder alloy, and a semiconductor component including the solder paste, or more specifically, to a lead-free solder alloy which has an excellent thermal cycle reliability and drop impact resistance and also is inexpensive to make, a solder paste including the lead-free solder alloy, and a semiconductor component including the solder paste.

### 2. Description of the Related Art

With environmental issues becoming increasingly important, the use of lead (Pb) in electronic products has been restricted. Lead-free solder alloys are inferior in some properties to lead-based solder alloys, and a solder composition with equal or superior properties to lead-based solder alloys is highly demanded. Particularly, as the thermal cycle reliability and drop impact resistance of such a solder composition are in an inverse proportional relationship, if these characteristics can both be improved at the same time, use of this solder composition for universal product development and use would not be limited to a certain product, which in turn could further reduce the development costs. Also, if expensive components could be excluded from a manufacturing process, the manufacturing costs could be even further reduced.

### SUMMARY

Provided is a lead-free solder alloy with an excellent thermal cycle reliability and drop impact resistance.

Provided is a solder paste including the lead-free solder alloy with an excellent thermal cycle reliability and drop impact resistance.

Provided is a semiconductor component including the lead-free solder alloy with an excellent thermal cycle reliability and drop impact resistance.

Additional aspects will be set forth in part in the description which follows and, in part, will be apparent from the description, or may be learned by practice of the presented embodiments of the disclosure.

According to an aspect of the disclosure, a lead-free and silver-free solder alloy includes: a primary metallic element in a content of about 1.1 wt %, to about 1.9 wt %; nickel (Ni) in a content of about 0.02 wt % to about 0.09 wt %; copper (Cu) in a content of about 0.2 wt % to about 0.9 wt %; and tin (Sn) and unavoidable impurities in remaining balance, wherein the primary metallic element is at least one selected from the group including bismuth (Bi), chromium (Cr), indium (In), antimony (Sb), silicon (Si) and zinc (Zn), which does not form compounds with tin (Sn).

In some embodiments, the lead-free solder alloy may further contain at least one selected from germanium (Ge), phosphorus (P), and gallium (Ga), and the total content of the at least one selected from Ge, P, and Ga may be about 2 ppm to about 500 ppm by weight.

In In some embodiments, the content of the primary metallic element may be about 1.3 wt % to about 1.7 wt %. In some embodiments, the primary metallic element may be bismuth (Bi).

In some embodiments, the content of nickel (Ni) may be about 0.035 wt % to about 0.09 wt %.

In some embodiments, the value of (the content of the first metallic element)/(the content of Ni) of the lead-free solder alloy may be about 10 to about 40.

In some embodiments, the lead-free solder alloy may further contain about 0.8 wt % to about 0.9 wt % of copper (Cu).

According to another aspect of the disclosure, provided is a solder paste including the lead-free solder alloy.

According to another aspect of the disclosure, a semiconductor component includes a substrate on which a plurality of primary terminals are formed, a semiconductor device mounted on the substrate and having a plurality of secondary terminals respectively matching with the plurality of primary terminals, and solder bumps that respectively connect each of the plurality of primary terminals to the plurality of secondary terminals, wherein the solder bump contains the lead-free solder alloy. In some embodiments, the solder bump may further contain about 0.3 wt % to about 1.2 wt % of silver (Ag).

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a chart showing a phase change temperature and undercooling temperature of lead-free solder alloys of Comparative Examples 1, 2, 4, and 5, and Embodiments 2, 4, and 5;

FIG. 2 is scanning electron microscope images of fracture surfaces taken after conducting a tension test on lead-free solder alloys of Comparative Examples 6 to 8, and Embodiments 2 to 5;

FIGS. 3A to 3C are charts showing the results of an interfacial bonding strength test conducted on solder balls attached to a Cu-OSP pad, wherein the solder balls include the lead-free solder alloys of Comparative Examples 1 and 2 and Embodiments 2 to 6;

FIG. 4 is a chart that shows a reliability position of solder balls having compositions of Comparative Examples 1, 2, and 9 and Embodiments 2 to 5, wherein the horizontal axis indicates the results of a drop impact resistance test, and the vertical axis indicates the results of a thermal cycle (TC) reliability test conducted on the solder balls attached to a Cu-OSP pad;

FIG. 5 shows scanning electron microscope images of an interface bonded with the lead-free solder alloys of Embodiments 3, 7, 8, and 9;

FIGS. 6A and 6B illustrate microscopic images that show fracturing aspects of different solder resist layer structures;

FIG. 7 is a chart that shows a position of solder balls having compositions of Comparative Example 10 and Embodiments 3, and 7 to 10, wherein the horizontal axis indicates results of a drop impact resistance test, and the vertical axis indicates results of a TC reliability test conducted on the solder balls attached to a Cu-OSP pad;

FIGS. 8A to 8C are charts showing results of an interfacial bonding strength test conducted on solder balls attached to a Ni/Au pad, wherein the solder balls include the lead-free solder alloys of Comparative Examples 1 and 2, and Embodiments 2 to 6;

FIG. 9 is a chart that shows a position of solder balls having compositions of Comparative Examples 1, 2, 9, and Embodiments 2 to 5, wherein the horizontal axis indicates results of a drop impact resistance test, and the vertical axis indicates results of a TC reliability test conducted on the solder balls attached to a Ni/Au pad; and

FIG. 10 is a schematic diagram of a semiconductor component according to an embodiment of the disclosure.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of at least one of the associated listed items. Expressions such as “at least one of,” when preceding a list of elements, modify the entire list of elements and do not modify the individual elements of the list.

Hereinafter, preferred embodiments of the present disclosure will be described in detail by referring to the accompanying drawings. However, the embodiments of the disclosure may be modified to various forms, and should not be construed as being limited by the embodiments described in detail below. It is preferable that the embodiments are construed as being provided to a person with an average knowledge in the art to explain the disclosure more completely. Like reference numerals refer to like elements throughout. Furthermore, various elements and regions in the drawings are schematic. Thus, the present disclosure is not limited by a relative size or interval in the accompanying drawings.

Terms like “primary”, “secondary”, or the like may be used to describe various components, but the components are not limited by the terms. The terms are used merely for the purpose of distinguishing one component from other components. For instance, a primary component may be named as a secondary component and vice versa, a secondary component may be named as a primary component without departing from the scope of the right of the disclosure.

The terms used herein were used to explain certain embodiments, and not to limit the scope of the disclosure. Singular expressions include plural expressions unless the meanings are clearly different in the context. The expression of “include” or “have” used herein indicates the presence of a characteristic, a number, a phase, a movement, an element, a component, or combinations of components described in the specification, and it should not be construed to exclude in advance the existence or possibility of existence of at least one of other characteristics, numbers, movements, elements, components, or combinations of components.

Unless otherwise defined, all terminologies used here including the technical terms and scientific terms mean the same as a person with an average knowledge in the art would commonly understand. Also, terminologies commonly used and defined in dictionaries should be interpreted to have the same meaning as they mean in the context of the related art, and unless clearly defined here, it should not be interpreted in excessively formal ways.

In case an embodiment could be otherwise embodied, certain process orders may be executed differently from the order described. For instance, two processes described consecutively may be performed practically at the same time or in the order opposite to the described order.

In regard to the attached drawings, modifications from the shown images could be anticipated due to manufacturing techniques, or/and tolerance. Thus, embodiments of the disclosure should not be construed to be limited to certain images shown in the present specification, and they should include modifications of images incurred by a manufacturing process, for instance. All expressions of “or/and” as used herein, include each of or all combinations of more than one of the stated components. Also, the term “substrate” as used herein, may mean a substrate itself or a substrate and a laminating structure formed on the surface of the substrate, including the layers and films. In addition, “surface of a substrate” as used herein, may mean the naked surface of a substrate itself, or the outer surface of layers or films formed on a substrate.

According to an embodiment of the disclosure, a lead-free solder alloy comprising a primary metallic element in an amount of about 0.6 wt % to about 5 wt %, nickel(Ni) in an amount of about 0.01 wt % to about 0.1 wt %, and tin (Sn) and other unavoidable impurities in remaining balance, is provided.

The term “main component” as used herein is a component that exceeds 50 parts by weight for 100 parts by weight of the total components of the lead-free solder alloy.

The term “unavoidable impurities” as used herein indicates impurities that are not added intentionally but are unintentionally added in a manufacturing process, and may indicate impurities less than 0.1 wt % by weight.

Primary Metallic Element

The lead-free solder alloy may contain the primary metallic element in an amount of about 1.1 wt % to about 1.9 wt %. The primary metallic element may be at least one selected from the group including bismuth (Bi), chromium (Cr), indium (In), antimony (Sb), silicon (Si) and zinc (Zn). In some embodiments, the primary metallic element may be bismuth (Bi).

The addition of the primary metallic element to a lead-free solder alloy may create an effect of increasing the hardness of the alloy.

When the content of the primary metallic element is too low, a thermal cycle reliability may be insufficient. When the content of the primary metallic element is too high, a drop impact resistance may be insufficient.

In some embodiments, the content of the primary metallic element may be about 1.3 wt % to about 1.7 wt %. Within the above range, the lead-free solder alloy has excellent thermal cycle reliability and drop impact resistance.

In some embodiments, the content of the primary metallic element may be about 1.4 wt % to about 1.6 wt %.

Nickel

The lead-free solder alloy may contain nickel (Ni) in an amount of about 0.02 wt % to about 0.09 wt %. The addition of nickel (Ni) to the lead-free solder alloy may stabilize an intermetallic compound (IMC) formed on an interface bonded to a pad by refining the grain structure.

When the content of nickel (Ni) is too low, a thermal cycle reliability may be insufficient. When the content of nickel (Ni) is too high, the intermetallic compound formed on the interface bonded to the pad may become unstable when electronic products are manufactured.

In some embodiments, the content of nickel (Ni) may be about 0.02 wt % to about 0.09 wt %, about 0.02 wt % to about 0.08 wt %, about 0.02 wt % to about 0.075 wt %, about 0.065 wt % to about 0.09 wt %, about 0.065 wt % to about 0.08 wt %, about 0.065 wt % to about 0.075 wt %, or any arbitrary range among them.

In some embodiments, a ratio of the content of the primary metallic element to the content of nickel (Ni), in other words, (the content of the first metallic element)/(the content of Ni), may be about 10 to about 40. In some embodiments, a value of (the content of the primary metallic element)/(the content of nickel) may be about 10 to about 30, about 10 to about 35, about 10 to about 30, about 13 to about 27, and about 13 to about 22. If the value of (the content of the primary element)/(the content of Ni) is within the above range, a lead-free solder alloy with even more excellent thermal cycle reliability and drop impact resistance is obtainable.

The lead-free solder alloy does not contain lead (Pb) or silver (Ag). Although lead (Pb) has favorable aspects in many characteristics in a solder alloy, it is harmful to the environment, and thus the lead-free solder alloy of the disclosure does not contain lead (Pb). Also, even though silver (Ag) is advantageous in retaining thermal cycle reliability, it is expensive, and when its content is increased, a drop impact resistance may decline. However, according to the disclosure, the lead-free solder alloy does not contain lead or silver, which means that lead or silver is not intentionally added, however, the lead-free solder alloy may contain lead or silver as unavoidable impurities.

In some embodiments, the lead-free solder alloy may further contain copper (Cu). At this time, a content of copper may be about 0.2 wt % to about 0.9 wt %. When the content of copper is too low, a copper pad may be excessively consumed at the interface with the copper pad. When the content of copper (Cu) is too high, undesirable intermetallic compounds could be excessively formed.

In some embodiments, the content of copper (Cu) may be about 0.2 wt % to about 0.9 wt %, about 0.5 wt % to about 0.9 wt %, about 0.8 wt % to about 0.9 wt %, or any arbitrary range among them.

In some embodiments, the lead-free solder alloy may not contain copper (Cu). When it is indicated that the lead-free solder alloy does not contain copper (Cu), this means that copper (Cu) is not intentionally added, however, the lead-free solder alloy may contain copper (Cu) as an unavoidable impurity.

In some embodiments, the lead-free solder alloy may further contain at least one selected from germanium (Ge), phosphorus (P), and gallium (Ga). The total content of at least one selected from germanium, phosphorus, and gallium may be about 2 ppm to about 500 ppm by mass.

In the lead-free solder alloy, when the total content of at least one selected from germanium (Ge), phosphorus (P), and gallium (Ga) is too low, an antioxidant effect on the tin component may be insufficient. When the total content of the at least one selected from germanium (Ge), phosphorus (P), and gallium (Ga) is too high, a wetting function on the pad may decline.

In some embodiments, the content of at least one selected from germanium (Ge), phosphorus (P), and gallium (Ga) may be about 5 ppm to about 400 ppm, about 10 ppm to about 300 ppm, about 20 ppm to about 200 ppm, about 50 ppm to about 100 ppm, or any arbitrary range among them.

The lead-free solder alloy described above may be provided in the forms of solder balls, solder paste, and the like.

The solder paste may contain about 3 parts by weight to about 25 parts by weight of flux for 100 parts by weight of the lead-free solder alloy. The flux may be RMA type flux for pastes for instance, and may be in a liquid form at room temperature. However, the flux is not limited thereto.

A mixture of the lead-free solder alloy and the flux can form a paste phase in room temperature.

A diameter of the solder ball may be about 10 μm to about 1000 μm, and the lead-free solder alloy may be provided after shaping it in spherical forms.

Moreover, the solder alloy may be supplied in arbitrary forms like cream, bar, or wire.

Hereinafter, the composition and effect of the disclosure will be described in more detail with reference to specific embodiments and comparative examples, however, the embodiments are merely for a clearer understanding of the disclosure, and not for limiting the scope of the disclosure.

Lead-free solder alloys, having the composition in Table 1 below were prepared in embodiments and comparative examples.

TABLE 1

| | Sn | Ag | Cu | Ni | Bi | In | Ge |
|---|---|---|---|---|---|---|---|
| Comparative | balance | 1.2 | 0.5 | 0.0500 | X | X | 0.0080 |
| Example 1 | | | | | | | |
| Comparative | balance | 3.0 | 0.5 | X | X | X | 0.0080 |
| Example 2 | | | | | | | |
| Comparative | balance | 2.5 | 0.8 | 0.0500 | 1.0 | X | 0.0080 |
| Example 3 | | | | | | | |
| Comparative | balance | 3.0 | 0.5 | 0.0750 | X | X | 0.0080 |
| Example 4 | | | | | | | |
| Comparative | balance | 4.0 | 0.5 | X | X | X | 0.0080 |
| Example 5 | | | | | | | |
| Comparative | 100 | X | X | X | X | X | X |
| Example 6 | | | | | | | |
| Comparative | balance | X | X | 0.0750 | 5.2 | X | 0.0080 |
| Example 7 | | | | | | | |
| Comparative | balance | X | X | 0.0750 | 7.0 | X | 0.0080 |
| Example 8 | | | | | | | |
| Comparative | balance | X | 0.8 | 0.0500 | 1.0 | X | 0.0080 |
| Example 9 | | | | | | | |
| Comparative | balance | X | 0.3 | 0.0750 | 2.1 | X | 0.0080 |
| Example 10 | | | | | | | |
| Embodiment 1 | balance | X | 0.3 | 0.0200 | 1.3 | X | 0.0080 |
| Embodiment 2 | balance | X | 0.3 | 0.0750 | 1.3 | X | 0.0080 |
| Embodiment 3 | balance | X | 0.3 | 0.0750 | 1.5 | X | 0.0080 |
| Embodiment 4 | balance | X | 0.5 | 0.0750 | 1.5 | X | 0.0080 |
| Embodiment 5 | balance | X | 0.5 | 0.0750 | 1.8 | X | 0.0080 |
| Embodiment 6 | balance | X | 0.5 | 0.0750 | 1.8 | 0.0500 | 0.0080 |
| Embodiment 7 | balance | X | 0.3 | 0.0750 | 1.8 | 0.0500 | 0.0080 |
| Embodiment 8 | balance | X | 0.8 | 0.0750 | 1.5 | 0.0500 | 0.0080 |
| Embodiment 9 | balance | X | 0.9 | 0.0750 | 1.5 | 0.0500 | 0.0080 |
| Embodiment 10 | balance | X | 0.8 | 0.0750 | 1.9 | 0.0500 | 0.0080 |
| Embodiment 11 | balance | X | 0.9 | 0.0500 | 1.3 | 0.0500 | 0.0080 |
| Embodiment 12 | balance | X | 0.8 | 0.0500 | 1.9 | 0.0500 | 0.0080 |
| Embodiment 13 | balance | X | 0.8 | 0.0200 | 1.8 | 0.0500 | 0.0080 |
| Embodiment 14 | balance | X | 0.9 | 0.0350 | 1.3 | 0.0500 | 0.0080 |

Undercooling Property Test

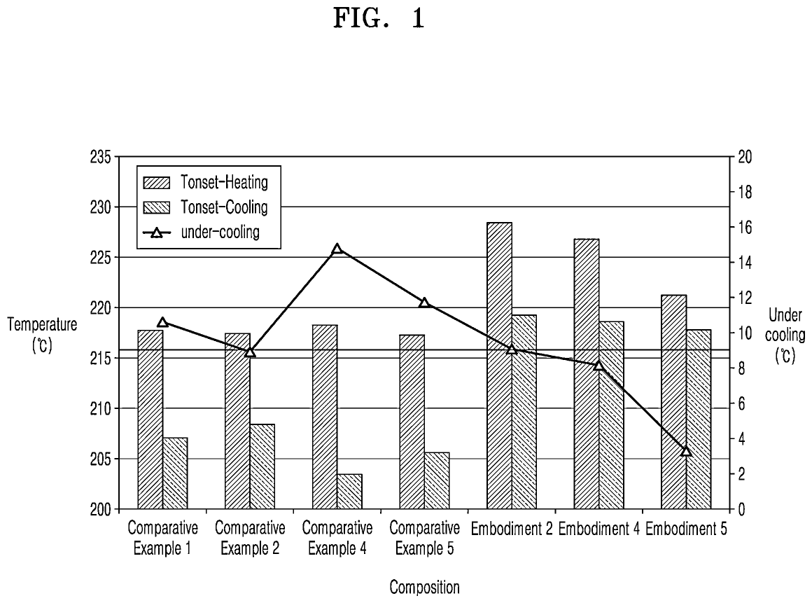

After solder balls including the lead-free solder alloys of Comparative Examples 1, 2, 4, and 5, and Embodiments 2, 4, and 5, were made, the temperatures when they started to change phase were measured and the difference (undercooling) was calculated. FIG. 1 is a chart that describes phase change temperatures and undercooling temperatures of the lead-free solder alloys of Comparative Examples 1, 2, 4, and 5, and Embodiments 2, 4, and 5.

“T onset—Heating” in FIG. 1 is the temperature corresponding to the peak representing the temperature when a solid begins to liquefy. “T onset—Cooling” is the temperature corresponding to the peak representing the temperature when a liquid begins to solidify. “Undercooling” is the difference between “T onset—Heating” and “T onset—Cooling”.

Referring to Comparative Examples of 2 and 4, undercooling increased due to the addition of nickel (Ni). With increased undercooling, the crystal structure is densified to increase strength, which may result in a decline of a drop impact resistance. Compared with the lead-free solder alloys of Comparative Examples containing silver (Ag), the lead-free solder alloys contain bismuth (Bi) in Embodiments 2, 4, and 5, undercooling is found to be markedly decreased.

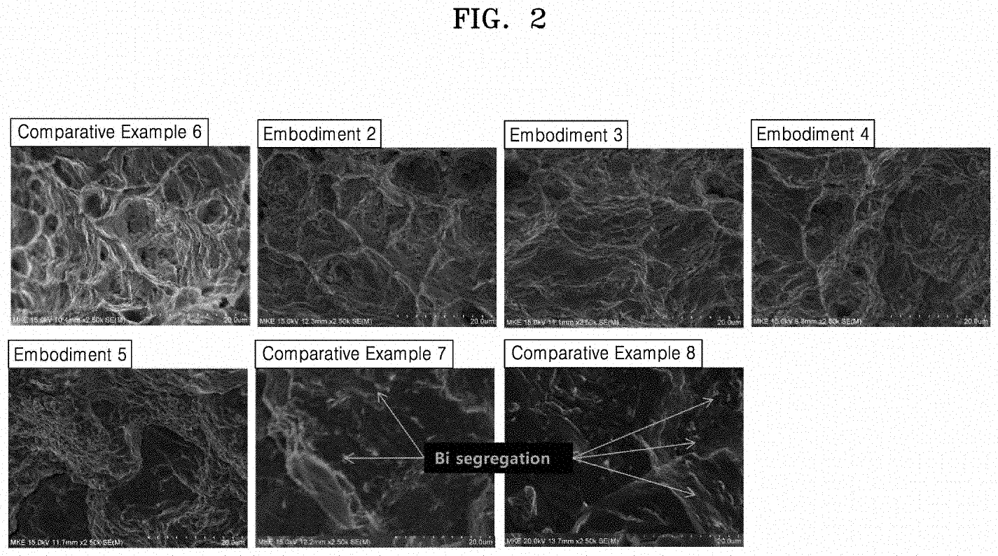

A tension test was conducted on the lead-free solder alloys of Comparative Examples 6 to 8, and Embodiments 2 and 5, and scanning electron microscope (SEM) images were taken for each fracture surface, and FIG. 2 shows the SEM images.

Referring to FIG. 2, brittle fracture with bismuth segregation was observed in the surfaces of Comparative Examples 7 and 8 which contain over 5 wt % of bismuth (Bi). Therefore, it is deducible to consider that an excessive bismuth content like over 5 wt % will cause an insufficient drop impact resistance and thermal cycle reliability.

On the other hand, ductile fracture was observed in the surfaces of the lead-free solder alloys of Embodiments 2 to 5. This means the lead-free solder alloys of Embodiments 2 to 5 have an excellent drop impact resistance and thermal cycle reliability.

Interfacial Bonding Strength Test (Cu-OSP Pad)

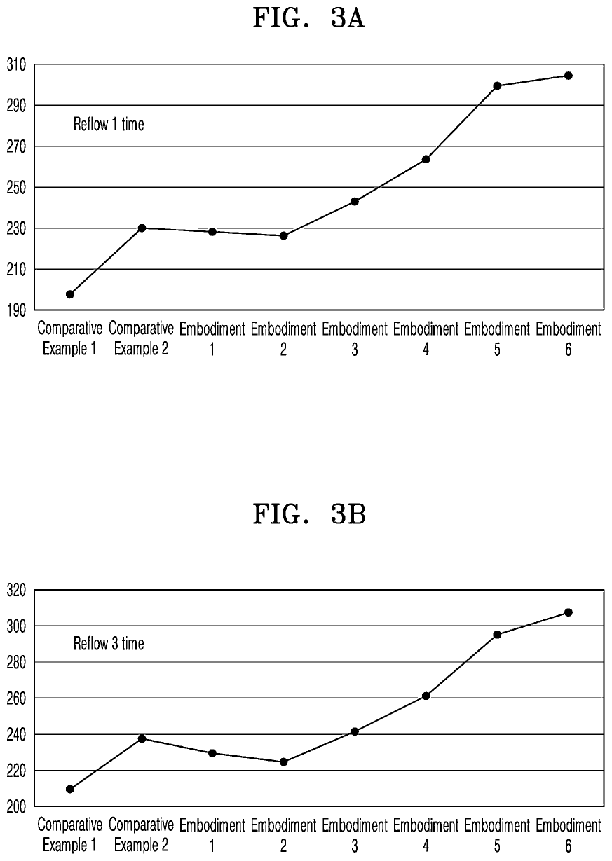

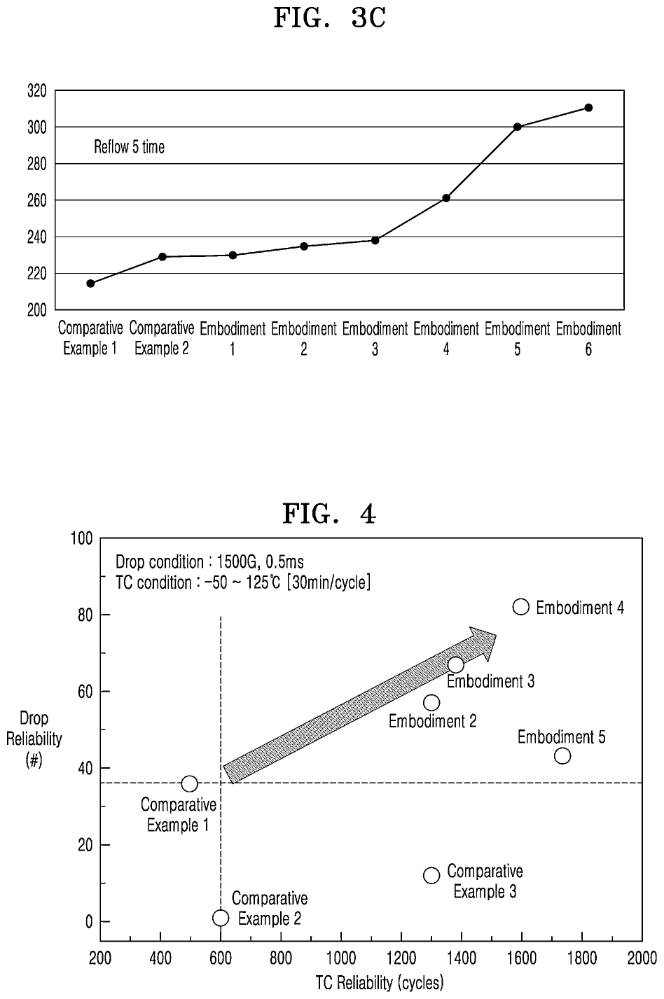

To measure the bonding hardness at the bonded interface, a non-destructive, brake strength test was conducted. Multiple samples were prepared by bonding solder balls including the lead-free solder alloys of Comparative Examples 1 and 2, and Embodiments 1 to 6 on a Cu-OSP pad, and a force was applied from the side with a tip, and the applied force was measured at a drop out. The test was conducted at a shear tip speed of 500 μm/sec, and a shear tip height set to 30 μm, the number of reflow times was changed (1 time, 3 times, 5 times), and the results are shown in Table 2 and FIGS. 3A to 3C.

TABLE 2

| | Reflow: 1 time | | Reflow: 3 times | | Reflow: 5 times | |
|---|---|---|---|---|---|---|
| | A | B | A | B | A | B |
| Comparative | 197.13 | 100 | 210.65 | 100 | 213.88 | 100 |
| Example 1 | | | | | | |
| Comparative | 229.14 | 116.2 | 237.95 | 113.0 | 227.89 | 106.6 |
| Example 2 | | | | | | |
| Embodiment 1 | 228 | 115.7 | 229.8 | 109.1 | 229.1 | 107.1 |
| Embodiment 2 | 225.93 | 114.6 | 224.26 | 106.5 | 234.07 | 109.4 |
| Embodiment 3 | 242.09 | 122.8 | 241.42 | 114.6 | 237.29 | 110.9 |
| Embodiment 4 | 263.34 | 133.6 | 261.4 | 124.1 | 260.46 | 121.8 |
| Embodiment 5 | 299.1 | 151.7 | 295.63 | 140.3 | 299.92 | 140.2 |
| Embodiment 6 | 304.11 | 154.3 | 308.06 | 146.2 | 310.19 | 145.0 |

A: Ball Shear Strength in g_{f}
B: Relative value with regard to Comparative Example 1

Referring to Table 2 and FIGS. 3A to 3C, the lead-free solder alloys of Embodiments 3 to 6 showed a markedly improved bonding strength with a Cu-OSP pad compared to the solder alloys of Comparative Examples 1 and 2. Specifically, the lead-free solder alloy of Embodiment 3 containing as little as 1.5 wt % of bismuth which is more affordable than silver, showed a better bonding strength than the solder alloy of Comparative Example 2 containing 3 wt % of silver, and the solder alloy of Embodiment 4 containing 2 wt % of bismuth showed a markedly better bonding strength than the solder alloy of Comparative Example 2.

Drop Impact Resistance Test (Cu-OSP Pad)

A semiconductor chip was prepared, wherein solder balls including the composition of Comparative Example 1 and having a diameter of 250 μm were each formed on Cu-OSP pads which had an opening diameter of 220 μm and were arranged at a 0.4 mm pitch. The total number of the solder balls was 402. In particular, the surface of the semiconductor chip around the solder ball was coated with a solder resist layer, and the solder resist layer had a side perpendicular to the surface of the semiconductor chip in the edge contacting the solder ball.

The semiconductor chip was attached to the printed circuit board having an opening diameter of 240 micrometers (μm) and being arranged at a pitch of 0.4 mm, and a drop impact resistance test was conducted. According to the assembly mechanical shock standard of JESD22-B110A, condition “B” using the acceleration of 1,500 G and 0.5 ms of a duration time was used to analyze the drop impact reliability, and the results are shown in Table 3.

The same experiment was conducted on the solder balls including the compositions of Comparative Examples 1, 2, 3, and Embodiments 2 to 5 and the results are shown in Table 3.

TABLE 3

| | Initial | | |
|---|---|---|---|
| | break-off | | |
| | (number of | Improvement | |
| | trials) | rate (%) | MTTF |
| Comparative Example 1 | 36 | 100(standard) | 87.0 |
| Comparative Example 2 | 1 | −97 | 28.6 |
| Embodiment 1 | 12 | −67 | 109.0 |
| Embodiment 2 | 57 | +58 | 210.1 |
| Embodiment 3 | 67 | +86 | 234.8 |
| Embodiment 4 | 82 | +128 | 266.3 |
| Embodiment 5 | 43 | +19 | 216.9 |

As shown in Table 3, the lead-free solder alloys of Embodiments 2 to 5 showed a markedly improved drop impact resistance compared to Comparative Examples 1, 2, and 9, which had a Bi content of 0, or less than 1.3 wt %. In addition, in terms of mean time to failure (MTTF), which is the mean time when 68% of solder balls becomes defective, the lead-free solder alloys of Embodiments 2 to 5 showed markedly better performances compared to the solder alloys of Comparative Examples 1, 2, and 9.

TC Reliability Test (Cu-OSP Pad)

A semiconductor chip was prepared, wherein solder balls including the composition of Comparative Example 1 and having a diameter of 250 μm were each formed on Cu-OSP pads which had an opening diameter of 220 μm and were arranged at a 0.4 mm pitch. The total number of the solder balls was 402.

The semiconductor chip was attached to the printed circuit board having an opening diameter of 240 micrometers (μm) and being arranged at a pitch of 0.4 mm, and a TC reliability test was conducted. As multiple cycles were performed on the sample so that the temperature went back and forth from −40° C. to +125° C. and a cycle took 30 minutes, an in situ resistance was measured. The number of cycles performed when the initial failure occurred was counted, and the results are shown in Table 4.

The same experiment was conducted on the solder balls including the composition of Comparative Examples 2 and 9, and Embodiments 2 to 5, and the results are shown in Table 4.

TABLE 4

| | Initial | |
|---|---|---|
| | break-off | |
| | (number of | Improvement |
| | trials) | rate (%) |
| Comparative Example 1 | 500 | −17 |
| Comparative Example 2 | 600 | 100 (standard) |
| Comparative Example 3 | 1300 | +117 |
| Embodiment 2 | 1301 | +117 |
| Embodiment 3 | 1383 | +131 |
| Embodiment 4 | 1598 | +166 |
| Embodiment 5 | 1728 | +188 |

As shown in Table 4, the lead-free solder alloys of Embodiments 2 to 5 showed a markedly improved TC reliability compared to solder alloys of Comparative Examples 1, 2, and 3 which have a Bi content of 0, or less than 1.0 wt %.

FIG. 4 is a chart that shows a position of the solder balls including the composition of Comparative Examples 2 and 3, and Embodiments 2 to 5; wherein the horizontal axis indicates the results of a drop impact resistance test, and the vertical axis indicates the results of a thermal cycle (TC) reliability test conducted on the solder balls attached to a Cu-OSP pad.

Referring to FIG. 4, the solder balls having the compositions of Embodiments 2 to 5 showed better properties in both drop impact resistance and TC reliability than the solder balls of Comparative Examples 1 and 2. The solder balls having the composition of Embodiments 2 to 5, compared to the solder ball of Comparative Example 3, were similar or better in terms of TC reliability and showed significantly better properties in terms of drop impact resistance.

Intermetallic Compound Layer (Drop Impact Resistance)

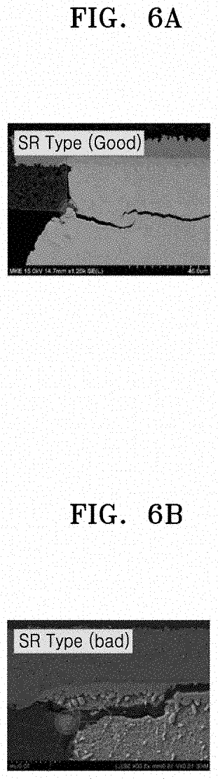

It is known that the drop impact resistance is greatly dependent on the shape of the portion contacting the solder bump of the solder resist layer (SR layer) formed on the semiconductor chip. That is, when the boundary portion of the SR layer is oblique (see FIG. 6B), the drop impact resistance is lowered, because the characteristics of the intermetallic compound layer play a big role. Therefore, the characteristics of the intermetallic compound layer become important, and it is necessary to stabilize the shape of the intermetallic compound layer to secure a stable drop impact resistance.

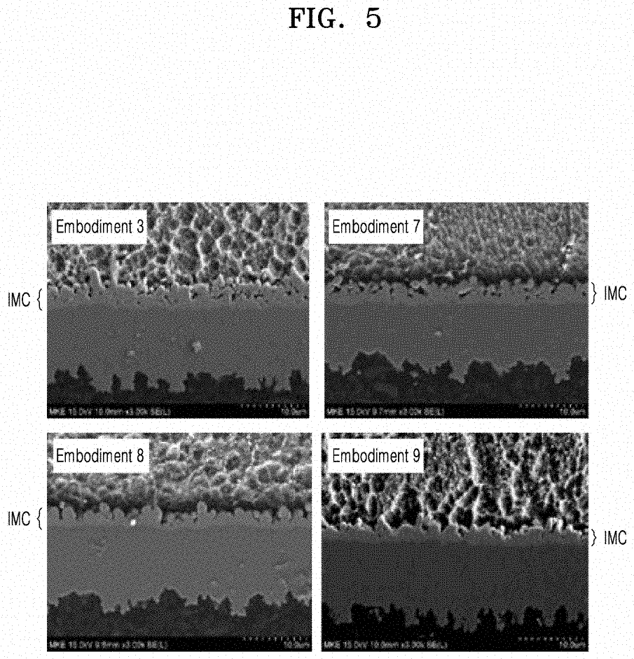

Scanning electron microscope images of the interface bonded with the lead-free solder alloys of Embodiments 3, 7, 8, and 9 are shown in FIG. 5.

As shown in FIG. 5, a plurality of pores and a relatively unstable structure were observed in the intermetallic compound layers of Embodiments 3 and 7. On the other hand, the intermetallic layers of Embodiments 8 and 9 were observed to have markedly less pores and a relatively stable structure.

In order to check a drop impact resistance, a semiconductor chip was prepared, wherein the solder balls including the composition of Embodiment 3 and having a diameter of 250 μm were each formed on Cu-OSP pads which had an opening diameter of 220 μm and were arranged at a 0.4 mm pitch. The total number of the solder balls was 402. In particular, the surface of the semiconductor chip around the solder ball was coated with a solder resist layer, and the solder resist layer had a side oblique to the surface of the semiconductor chip in the edge contacting the solder ball.

The semiconductor chip was attached to the printed circuit board having an opening diameter of 240 micrometers (μm) and being arranged at a pitch of 0.4 mm, and a drop impact resistance test was conducted. According to the assembly mechanical shock standard of JESD22-B110A, condition “B” using the acceleration of 1500 G and 0.5 ms of duration time was used to analyze the drop impact reliability, and the results are shown in Table 5 below.

When the SR layer is different, the characteristics of the intermetallic compound layer have a big influence on the drop impact resistance, and the result of different fracturing aspects is shown in FIGS. 6A and 6B. In other words, as shown in FIGS. 6A and 6B, the propagation direction of the crack may vary depending on the shape of the SR layer. Specifically, as shown in FIG. 6A, when the boundary portion of the SR layer has a side not oblique but perpendicular, the crack tended to propagate toward the bulk of the solder ball, and as shown in FIG. 6B, when the boundary portion is obliquely inclined, the crack tended to propagate in the direction of the intermetallic compound layer (i.e., the upward direction of FIG. 6B). The propagation direction of the cracks is closely related to a drop impact resistance.

The same experiment was conducted on the solder balls including the composition of Comparative Examples 10, and Embodiments 7 to 14 and the results are shown in Table 5.

TABLE 5

| | Initial | |
|---|---|---|
| | break-off | |
| | (number of | Improvement |
| | trials) | rate (%) |
| Comparative Example 1 | 38 | +52 |
| Comparative Example 2 | 2 | −92 |
| Comparative Example 10 | 18 | −28 |
| Embodiment 3 | 25 | 100(standard) |
| Embodiment 7 | 31 | +24 |
| Embodiment 8 | 45 | +80 |
| Embodiment 9 | 78 | +212 |
| Embodiment 10 | 34 | +36 |

Referring to the results of Embodiment 3 shown in Table 3 and Table 5, when the form of the SR layer was not perpendicularly stable (i.e., it was oblique), a result of a 65% decrease in a drop impact resistance, that is, from 67 times to 25 times, was observed. This is understood like the results in FIG. 5, that is, when the content of Cu is low, the drop impact resistance is lowered because of the porous character of the interface IMC. Therefore, it was confirmed in cases of Embodiments 4, 8, and 9 with a relatively high Cu content, that the porous interfacial IMC is stabilized, and thus, the drop impact resistance also improved.

As shown in Table 5, it was confirmed that the drop impact resistance was significantly insufficient in case of Comparative Example 10, which had a Bi content exceeding 1.9 wt %. In addition, it was confirmed by comparing Embodiments 3, and 7 to 9, that when the Bi content is higher or the Cu content is higher the drop impact resistance improves.

Intermetallic Compound (TC Reliability)

A semiconductor chip was prepared, wherein the solder balls including the composition of Embodiment 3 and having a diameter of 250 μm were each formed on Cu-OSP pads which had an opening diameter of 220 μm and were arranged at a 0.4 mm pitch. The total number of the solder balls was 402.

The semiconductor chip was attached to the printed circuit board having an opening diameter of 240 micrometers (μm) and being arranged at a pitch of 0.4 mm, and a TC reliability test was conducted. As multiple cycles were performed on the sample wherein the temperature went back and forth from −40° C. to +125° C. and a cycle took 30 minutes, an in situ resistance was measured. The number of cycles performed when the initial failure occurred was counted, and the results are shown in Table 6.

The same experiment was conducted for the solder balls having the composition of Comparative Example 2, and Embodiments 7 to 14, and the results are shown in Table 6.

TABLE 6

| | Initial | |
|---|---|---|
| | break-off | |
| | (number of | Improvement |
| | trials) | rate (%) |
| Comparative Example 1 | 460 | −18 |
| Comparative Example 2 | 560 | 100(standard) |
| Comparative Example 10 | 1480 | −164 |
| Embodiment 3 | 1335 | +138 |
| Embodiment 7 | 1386 | +148 |
| Embodiment 8 | 1408 | +151 |
| Embodiment 9 | 1457 | +160 |
| Embodiment 10 | 1589 | +184 |

As shown in Table 6, the lead-free solder alloys of Embodiments 3, and 7 to 10 showed a markedly improved TC reliability compared to the solder alloys of Comparative Example 2 which had a Bi content less than 1.3 wt %.

FIG. 7 is a chart that shows a position of the solder balls having the composition of Comparative Examples 1, 2, and 10, and Embodiments 3, and 7 to 10, wherein the horizontal axis indicates the results of a drop impact resistance test, and the vertical axis indicates the results of a thermal cycle (TC) reliability test conducted on the solder balls attached to a Cu-OSP pad.

Referring to FIG. 7, the solder balls having the composition of Embodiments 3, and 7 to 10 showed a markedly improved TC reliability than the solder balls of Comparative Examples 1 and 2. The solder balls having the composition of Embodiments 8 to 10 compared to the solder balls of Comparative Example 10, and Embodiments 3 and 7, showed better results in terms of the drop impact resistance, but in terms of TC reliability, there was no significant difference.

Particularly, in case of the lead-free solder alloys having the composition of Embodiments 8 and 9, compared to the alloys of Comparative Example 1, and Embodiments 3 and 7, that have a more Bi content, a better drop impact resistance was measured.

Interfacial Bonding Strength Test (Ni/Au Pad)

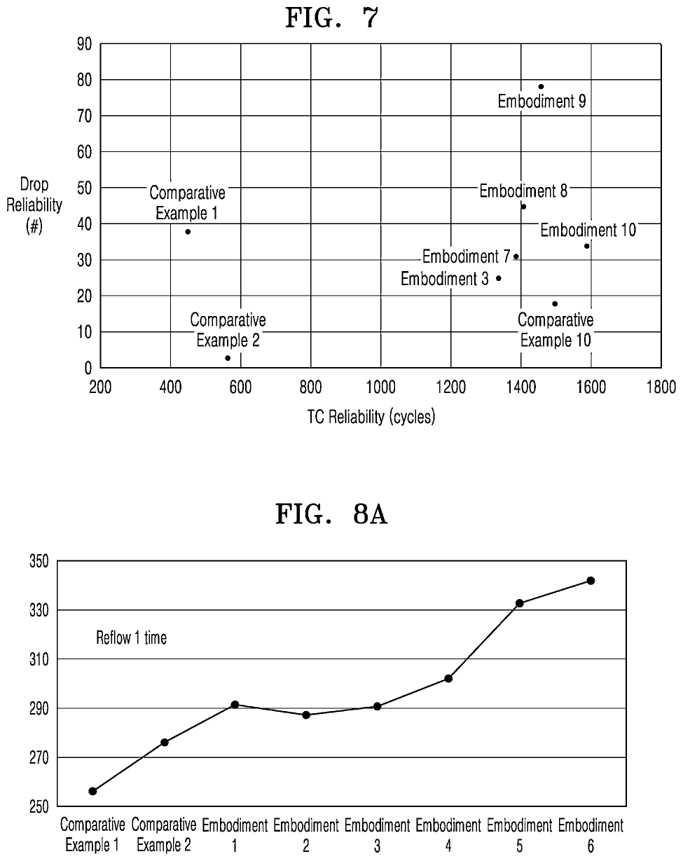

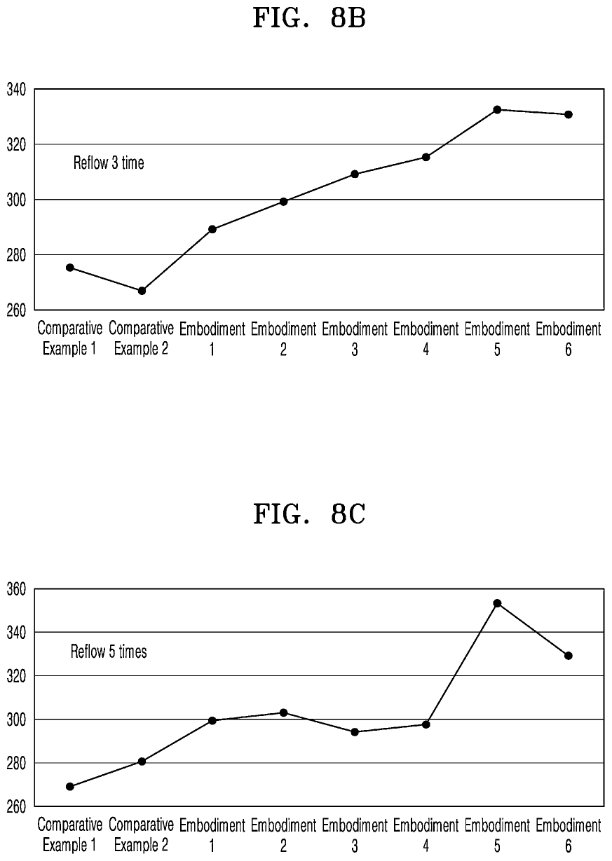

To measure the bonding hardness at the bonded interface, a non-destructive, brake strength test was conducted. Multiple samples were prepared by bonding solder balls including the lead-free solder alloys of Comparative Examples 1 and 2, and Embodiments 1 to 6 on a Ni/Au pad, and a force was applied from the side with a tip, and the applied force was measured at a drop out. The test was conducted with a shear tip speed of 500 μm/sec, and a shear tip height set to 30 μm, the number of reflow times was changed (1 time, 3 times, 5 times), and the results are shown in Table 7 and FIGS. 8A to 8C.

TABLE 7

| | Reflow 1 time | | Reflow 3 times | | Reflow 5 times | |
|---|---|---|---|---|---|---|
| | A | B | A | B | A | B |
| Comparative | 256.61 | 100 | 274.84 | 100 | 269.16 | 100 |
| Example 1 | | | | | | |
| Comparative | 276.08 | 107.6 | 266.19 | 96.9 | 280.41 | 104.2 |
| Example 2 | | | | | | |
| Embodiment 1 | 291.48 | 113.6 | 289.3 | 105.3 | 299.32 | 111.2 |
| Embodiment 2 | 287.51 | 112.0 | 298.87 | 10837 | 303.15 | 112.6 |
| Embodiment 3 | 290.79 | 113.3 | 308.7 | 112.3 | 294.21 | 109.3 |
| Embodiment 4 | 302.8 | 118.0 | 315.55 | 114.8 | 297.25 | 110.4 |
| Embodiment 5 | 332.34 | 129.5 | 332.24 | 120.9 | 353.03 | 131.2 |
| Embodiment 6 | 341.56 | 133.1 | 330.67 | 120.3 | 329.77 | 122.5 |

A: Ball Shear Strength in g_{f}
B: Relative value with regard to Comparative Example 1

Referring to Table 7 and FIGS. 8A to 8C, the lead-free solder alloys of Embodiments 3 to 6 showed a markedly improved bonding strength with a Ni/Au pad compared to the solder alloys of Comparative Examples 1 and 2. Specifically, the lead-free solder alloys of Embodiments 1 to 3 containing as little as 1.0 wt % or 1.5 wt % of bismuth which is more affordable than silver, showed a better bonding strength than the solder alloy of Comparative Example 2 containing 3 wt % of silver, and the lead-free solder alloy of Embodiment 4 containing 2 wt % of bismuth showed a markedly better bonding strength than the solder alloy of Comparative Example 2.

Drop Impact Resistance Test (Ni/Au Pad)

A semiconductor chip was prepared, wherein solder balls including the composition of Comparative Example 1 and having a diameter of 250 μm were each formed on Ni/Au pads which had an opening diameter of 220 μm and were arranged at a 0.4 mm pitch. The total number of the solder balls was 402.

The semiconductor chip was attached to the printed circuit board having an opening diameter of 240 micrometers (μm) and being arranged at a pitch of 0.4 mm, and a drop impact resistance test was conducted. According to the assembly mechanical shock standard of JESD22-B110A, condition “B” using the acceleration of 1500 G and 0.5 ms of duration time was used to analyze the drop impact reliability, and the results are shown in Table 8 below.

The same experiment was conducted on the solder balls including the composition of Comparative Examples 2 and 3, and Embodiments 2, 3, 5, and 10, and the results are shown in Table 8.

TABLE 8

| | Initial | | |
|---|---|---|---|
| | break-off | | |
| | (number of | Improvement | |
| | trials) | rate (%) | MTTF |
| Comparative Example 1 | 34 | 100(standard) | 131.5 |
| Comparative Example 2 | 5 | −85.3 | 49.6 |
| Comparative Example 3 | 11 | −67.6 | 99.5 |
| Embodiment 2 | 82 | +141.2 | 305.9 |
| Embodiment 3 | 43 | +26.5 | 160.8 |
| Embodiment 5 | 29 | −14.7 | 44.8 |
| Embodiment 10 | 7 | −79.4 | 23.2 |

As shown in Table 8, the lead-free solder alloys of Embodiments 2 and 3 showed a markedly improved drop impact resistance compared to the solder alloy of Comparative Example 1. The lead-free solder alloy of Embodiment 5 showed a markedly better drop impact resistance compared to the solder alloys of Comparative Examples 2 and 3, but showed a slightly insufficient drop impact resistance compared to the solder alloy of Comparative Example 1.

In addition, in terms of mean time to failure (MTTF), which is the mean time of 68% of solder balls becoming defective, the lead-free solder alloys of Embodiments 2 and 3 showed markedly better performances compared to the solder alloys of Comparative Examples 1, 2, and 3.

TC Reliability Test (Ni/Au Pad)

A semiconductor chip was prepared, wherein solder balls including the composition of Comparative Example 1 and having a diameter of 250 μm were each formed on Ni/Au pads which had an opening diameter of 220 μm and were arranged at a 0.4 mm pitch. The total number of the solder balls was 402.

The semiconductor chip was attached to the printed circuit board which had an opening diameter of 240 micrometers (μm) and were arranged at a pitch of 0.4 mm, and a TC reliability test was conducted. As multiple cycles were performed on the sample wherein the temperature went back and forth from −40° C. to +125° C. and a cycle took 30 minutes, an in situ resistance was measured. The number of cycles performed when the initial failure occurred was counted, and the results are shown in Table 9.

The same experiment was conducted on the solder balls including the composition of Comparative Examples 2, and 3, and Embodiments 2, 3, 5 and 10, and the results are shown in Table 9.

TABLE 9

| | Initial | |
|---|---|---|
| | break-off | |
| | (number of | Improvement |
| | trials) | rate (%) |
| Comparative Example 1 | 1000 | −29 |
| Comparative Example 2 | 1400 | 100 (standard) |
| Comparative Example 3 | 2100 | +50 |
| Embodiment 2 | 2350 | +68 |
| Embodiment 3 | >3000 | >+200 |
| Embodiment 5 | >3000 | >+200 |
| Embodiment 10 | >3000 | >+200 |

As shown in Table 9, the lead-free solder alloys of Embodiments 2, 3, 5, and 10 showed a markedly improved TC reliability compared to the solder alloys of Comparative Examples 1, 2, and 3. Particularly, the lead-free solder alloys of Embodiments 3, 5, and 10 did not fracture at all as the experiment was conducted 3,000 times, and therefore, if more than 3,000 experiments were conducted, a higher value would have been obtained.

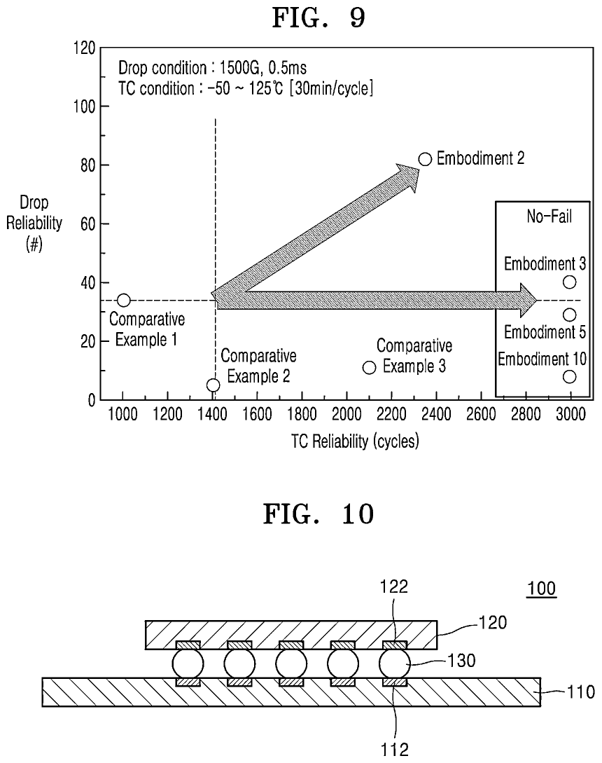

FIG. 9 is a chart that shows a position of the solder balls having the composition of Comparative Examples 1, 2, and 3, and Embodiments 2, 3, 5, and 10, wherein the horizontal axis indicates the results of a drop impact resistance test, and the vertical axis indicates the results of a thermal cycle (TC) reliability test conducted on the solder balls attached to a Ni/Au pad.

Referring to FIG. 9, the solder balls including the composition of Embodiment 2 showed markedly better properties in both drop impact resistance and TC reliability compared to the solder balls of Comparative Examples of 1, 2, and 3. Also, the solder balls including the composition of Embodiments 3, 5, and 10 were similar or better in terms of the drop impact resistance, and showed markedly better properties in terms of TC reliability compared to the solder balls of Comparative Examples 1, 2, and 3.

In particular, the alloy of Embodiment 10 having a Bi content of 1.9 wt % had small undercooling as shown in FIG. 1, and was anticipated to have an excellent impact resistance, however, as the hardness of the solder also increased, the drop impact resistance was marginally good. However, it was confirmed that the drop impact resistance was still better compared to the solder alloys of Comparative Examples 1 and 2.

<Preparation of a Solder Paste>

Powders having the composition of Embodiments 1 to 6 were prepared using a vacuum gas atomizer and then powder of type 4 with a diameter of about 20 μm to about 38 μm was obtained using a sieve. At this time, a melting temperature was 550° C., and argon (Ar) gas was used in the vacuum gas atomizer.

Then, solder pastes were prepared by adding 12 parts by weight of RMA type flux for pastes to the 100 parts by weight of the powder and mixing at a speed of 1,000 rpm for 3 minutes and 30 seconds using a paste mixer.

<Preparation of Solder Bars and Solder Balls>

Solder bars having the compositions of Embodiments 1 to 6 were prepared using a vacuum degassing alloying device, wherein a processing temperature was 500° C. Further, a bubbling process and a vacuum degassing process were performed before tapping to prepare the alloy solder bar.

In addition, solder balls of a diameter of 0.3 mm were prepared using the prepared alloy solder bars.

Another aspect of the present disclosure is to provide a semiconductor component. FIG. 10 shows a semiconductor component 100 according to an embodiment of the disclosure.

Referring to FIG. 10, a substrate 110 on which a plurality of primary terminals 112 are formed is provided. The substrate 110 may be, for instance, a printed circuit board (PCB) or a flexible printed circuit board (FPCB).

In some embodiments, the primary terminals 112 may be an Organic Solderability Preservative copper (Cu-OSP) pad.

In some embodiments, the primary terminals 112 may be a bonding pad having an electroplated nickel layer. The bonding pad having an electrolytic nickel layer may be a bonding pad including an electrolytic nickel layer formed on top of the copper pad by electric gilding and a gold layer formed on top of the electrolytic nickel layer.

In some embodiments, the primary terminals 112 may be a bonding pad having an electroless nickel layer. The bonding pad having an electroless nickel layer may be, for instance, a pad such as an electroless nickel-immersion gold (ENIG), or an electroless nickel-electroless palladium-immersion gold (ENEPIG).

The plurality of primary terminals 112 may be a bump pad on which a bump can be attached, and may have a structure including one metal layer or laminated plurality of metal layers. In addition, the primary terminals 112 may be copper (Cu), aluminum (Al), nickel (Ni). or an alloy of two or more kinds thereof, but are not limited thereto.

A semiconductor device 120 may be mounted on the substrate 110 which has a plurality of secondary terminals 122 matching with the plurality of primary terminals 112. The secondary terminals 122 may be, for instance, a flash memory, a phase-change RAM (PRAM), a resistive RAM (RRAM), a ferroelectric RAM (FeRAM), or a magnetic RAM (MRAM), and the like, but are not limited thereto. The flash memory may be, for instance, not- and (NAND) flash memory. The semiconductor device 120 may include one semiconductor chip, or several semiconductor chips that are laminated. The semiconductor device 120 may be a semiconductor chip, or a semiconductor package where the semiconductor chip is mounted on a package substrate, and the semiconductor chip may be encapsulated by an encapsulating material.

The plurality of primary terminals and the matching plurality of secondary terminals may be each connected by a solder bump. At this time, the solder bump 130 may be formed to include a lead-free solder alloy having the composition as mentioned above.

In some embodiments, the solder bump 130 may be formed by using both the solder ball having the above-mentioned composition and a conventional solder paste including silver (for instance, a lead-free solder paste containing 3.0 wt % of silver and 0.5 wt % of copper). In this case, the solder bump 130 may have a copper content of about 0.1 wt % or more and/or a silver content of 0.5 wt % or more.

In some embodiments, the content of silver of the solder bump 130 may be about 0.3 wt % to about 1.1 wt %.

When the substrate 110 and the semiconductor device 120 are connected by such a solder bump 130, a highly reliable solder junction with a high impact resistance and thermal impact properties can be obtained.

When semiconductor components are manufactured by using the solder balls or solder pastes having the composition of the lead-free solder alloy of the disclosure, the semiconductor components have excellent thermal cycle reliability and resistance to drop impacts. Also, because the composition does not include silver (Ag), which is expensive, the manufacturing costs may be reduced significantly.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. A lead-free solder alloy comprising:
a primary metallic element in a content of about 1.1 wt % to about 1.9 wt %;
nickel (Ni) in a content of about 0.02 wt % to about 0.09 wt %;
copper (Cu) in a content of about 0.2 wt % to about 0.9 wt %; and
tin (Sn) and other unavoidable impurities in remaining balance,
wherein,
the primary metal element is a metal that does not form an intermetallic compound (IMC) with tin (Sn), and comprises at least one selected from the group consisting of bismuth (Bi), chromium (Cr), indium (In), antimony (Sb), silicon (Si), and zinc (Zn),
and the lead-free solder alloy does not include lead (Pb) and silver (Ag).

2. The lead-free solder alloy of claim 1, further comprising
at least one selected from germanium (Ge), phosphorus (P), and gallium (Ga), wherein
a total content of the at least one selected from germanium (Ge), phosphorus (P), and gallium (Ga) is about 2 ppm to about 500 ppm.

3. The lead-free solder alloy of claim 1, wherein,
the content of the primary metallic element is about 1.3 wt % to about 1.7 wt %.

4. The lead-free solder alloy of claim 1, wherein,
the primary metallic element is bismuth (Bi).

5. The lead-free solder alloy of claim 1, wherein,
the content of nickel (Ni) is about 0.035 wt % to about 0.09 wt %.

6. The lead-free solder alloy of claim 1, wherein,
a value of (the content of the primary metallic element)/(the content of nickel) is about 10 to about 40.

7. The lead-free solder alloy of claim 1, wherein,
the content of copper is about 0.8 wt % to about 0.9 wt %.

8. A solder paste comprising the lead-free solder alloy according to claim 1.

9. A solder ball comprising the lead-free solder alloy according to claim 1.

10. A semiconductor component comprising:
a substrate on which a plurality of primary terminals are formed;
a semiconductor device mounted on the substrate and having a plurality of secondary terminals respectively matching with the plurality of primary terminals; and,
solder bumps respectively connecting each of the plurality of primary terminals to each of the plurality of secondary terminals, wherein
the solder bump comprises a lead-free solder alloy according to any one of claims 1 to 7.

11. The semiconductor component of claim 10, wherein,
the content of silver is about 0.3 wt % to about 1.2 wt %.
